(19) United States
(12) Patent Application Publication
(10) Pub. No.: US 2026/0021867 A1
(43) Pub. Date: Jan. 22, 2026

(54) SUSPENSION ARRANGEMENT FOR A BICYCLE

(71) Applicant: SRAM, LLC, CHICAGO, IL (US)

(72) Inventor: TIMOTHY LYNCH, COLORADO SPRINGS, CO (US)

(73) Assignee: SRAM, LLC, CHICAGO, IL (US)

(21) Appl. No.: 19/262,921

(22) Filed: Jul. 8, 2025

Related U.S. Application Data
(60) Provisional application No. 63/672,197, filed on Jul. 16, 2024.

(51) Int. Cl. B62K 25/08; B62J 1/06; B62K 25/10

(52) U.S. Cl. CPC B62K 25/08; B62J 1/06; B62K 25/10; B62K 2201/08

(57) ABSTRACT

A suspension component for a bicycle is provided. The suspension component may include a first positive chamber, a piston movable through the first positive chamber along an axis from a first position to a second position in a compression direction, and a positive chamber passage in fluid communication with the first positive chamber with the piston in the first position, and separated from fluid communication with the first positive chamber with the piston in the second position. A second positive chamber may be provided in fluid communication with the positive chamber passage, wherein the second positive chamber is at least in part overlapping the first positive chamber in a radial dimension relative to the axis.

This application claims the benefit of U.S. Provisional Patent Application 63/672,197, filed Jul. 16, 2024, the contents of which are hereby incorporated by reference in its entirety.

### FIELD

The present disclosure relates to bicycle components, and more specifically to suspension components for bicycles.

### BACKGROUND

Bicycles are known to have suspension components. Suspension components are useful in various applications for cushioning impacts, isolating a sprung mass including a rider from vibrations and terrain features, and maintaining tire contact with the riding surface. Suspension components may generally be defined in terms of spring rates, with changes in spring rate possible throughout movement or travel of such components. In order to meet applications such as those described above, control of spring rates is desirable.

As such, there is a need for suspension arrangements that facilitate control and tunability of spring rates to achieve impact, isolation, traction, and other suspension objectives.

### SUMMARY

An object of this disclosure is to describe various suspension arrangements to manage unsprung and sprung masses. Suspension components may be provided with one or more springs, including air springs. The described suspension arrangements may advantageously provide a controlled and tunable spring rate curve to achieve various impact, isolation, traction, and other suspension objectives.

One aspect provides a suspension component for a bicycle, the suspension component comprising: a first positive chamber; a piston movable through the first positive chamber along an axis from a first position to a second position in a compression direction; a positive chamber passage in fluid communication with the first positive chamber with the piston in the first position, and separated from fluid communication with the first positive chamber with the piston in the second position; and a second positive chamber in fluid communication with the positive chamber passage, wherein the second positive chamber is disposed at least in part overlapping the first positive chamber in a radial dimension relative to the axis.

Another aspect provides a suspension component for a bicycle, the suspension component comprising: a positive chamber; a negative chamber; a piston movable along an axis in a compression direction, the piston comprising: a first seal; and a second seal spaced apart from the first seal along the axis, wherein at least one of the first seal and the second seal is operable to fluidly separate the positive chamber and the negative chamber; a bypass device, the bypass device comprising: a first bypass feature; and a second bypass feature spaced apart from the first bypass feature along the axis, wherein the first bypass feature and the second bypass feature cooperate to selectively permit fluid communication between the positive chamber and the negative chamber throughout travel of the piston along the axis.

### BRIEF DESCRIPTION OF THE DRAWINGS

FIG. 1 is a side view of an example bicycle that can employ any of the example suspension arrangements disclosed herein.

FIG. 2 is a schematic sectional view of a suspension component in an extended position that can be implemented on the example bicycle of FIG. 1.

FIG. 3 is a schematic sectional view of the suspension component of FIG. 2 in a first compressed position.

FIG. 4 is a schematic sectional view of the suspension component of FIG. 2 in a second compressed position.

FIG. 5 is a schematic sectional view of the suspension component of FIG. 2 in a third compressed position.

FIG. 6 is a perspective view of an example front fork that can be implemented on the example bicycle of FIG. 1.

FIG. 7 is a partial sectional view of the example front fork of FIG. 6.

FIG. 8 is an enlarged partial sectional view of the example front fork in FIGS. 6 and 7.

The figures may not be to scale. Instead, the thickness of the layers or regions may be enlarged in the drawings. In general, the same reference numbers will be used throughout the drawing(s) and accompanying written description to refer to the same or like parts.

Other aspects and advantages of the embodiments disclosed herein will become apparent upon consideration of the following detailed description, wherein similar or identical structures may have similar or identical reference numerals.

### DETAILED DESCRIPTION

Reference will now be made in detail to present embodiments of the invention, one or more embodiments of which are illustrated in the accompanying drawings. The detailed description uses numerical and letter designations to refer to features in the drawings. Like or similar designations in the drawings and description have been used to refer to like or similar parts of the invention.

The word “exemplary” is used herein to mean “serving as an example, instance, or illustration.” Any implementation described herein as “exemplary” is not necessarily to be construed as preferred or advantageous over other implementations.

The descriptors used herein, including the terms “first”, “second”, “third”, etc. may be used interchangeably to distinguish one component from another and are not intended to signify location or importance of the individual components. Unless otherwise specified or understood based on their context of use, such descriptors are not intended to impute any meaning of priority or ordering in time but merely as labels for referring to multiple elements or components separately for ease of understanding the disclosed embodiments. In some embodiments, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Various suspension components may be provided with reference to the following disclosure. For example, front suspension forks, rear suspension shocks, seatposts, and various other suspension components are contemplated in connection with the features that follow. Proceeding with the example of front suspension on a bicycle, a front fork typically includes a crown, a steerer tube extending upward from the crown, and two legs extending downward from the crown. Each leg has an upper tube that is connected to the crown and a lower tube that is to be connected to the front wheel. The upper and lower tubes are arranged in a telescopic relationship. In some instances, a damper is disposed in one of the legs and a spring (e.g., an air spring, a coil spring) is disposed in the other leg. The spring enables the front fork to compress or contract when riding over a bump or obstacle, thereby reducing the transmission of shocks and vibrations to the rider, and then returns the fork to an expanded state after the compressive force is removed. There are many elements that can affect the transmission of force through the front fork, such as damping, chassis stiffness, and the spring rate.

Various suspension components on a bicycle may employ air springs to at least in part provide support for the rider. Such components include front forks, rear shocks, suspension seatposts, and movable seatposts that employ one or more air chambers to support the rider. Air springs may generally be provided with at least one positive chamber that provides spring pressure to resist compression. At least one negative chamber may further be provided, where the negative pressure and positive pressure are in equilibrium in an uncompressed state. Although such a configuration may be used, it is also contemplated that a mechanical top out may be provided prior to this equilibrium state being achieved. Providing a combination of a positive air spring and a negative air spring can help provide a low breakaway force (i.e. minimizing a force required to begin travel movement) into compression and reduce the possibility and severity of full rebound events into minimum compression states.

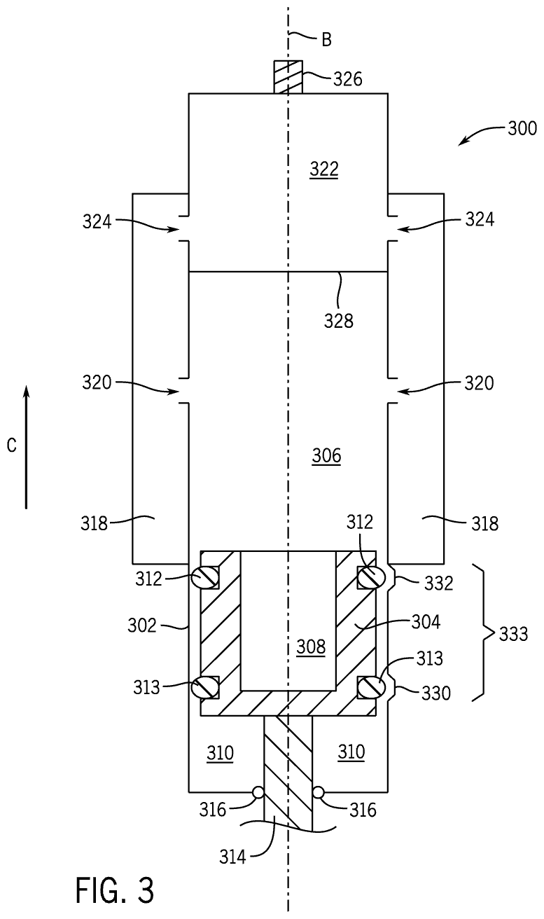

At least one bypass feature may further be provided to maintain a desired relative pressure between the positive and negative air springs. For example, at least one bypass feature may be provided such that the positive and negative air springs are in fluid communication and thus equalized in pressure at a partial compression state of a suspension component as described in greater detail with reference to FIG. 3 below. In this example, as the suspension component rebounds to a point where the bypass feature no longer allows communication between the positive and negative air springs, the pressure in the negative air spring increases relative to the pressure in the positive air spring. In an example, the negative air spring employs a smaller working area than that of the positive air spring, such that at a certain pressure higher relative to that of the positive air spring, an equilibrium force between the positive and negative air springs is achieved.

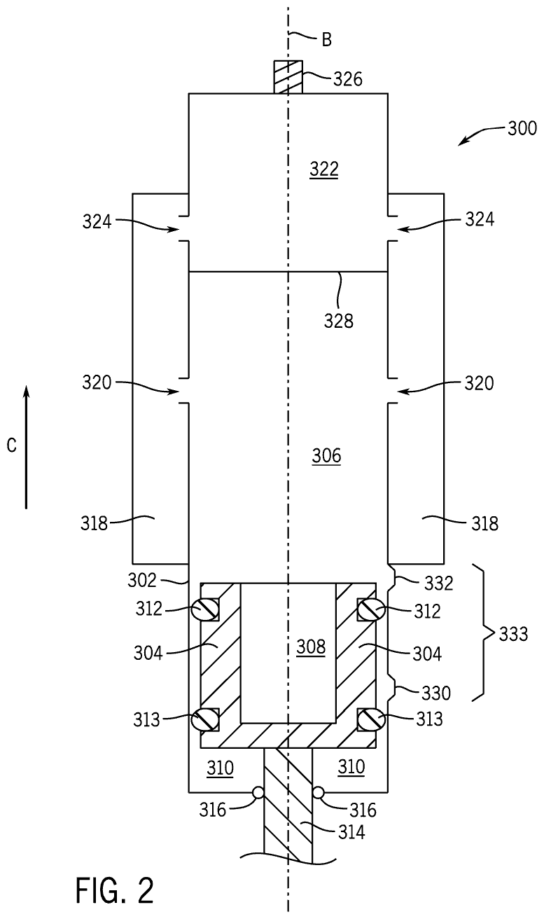

The positive air spring may include a plurality of positive air chambers. For example, a positive air spring may be provided with a first positive air chamber and a second positive air chamber, where the second positive air chamber only contributes to the positive air spring during a portion of the compression travel of the suspension component. As will be discussed further with reference to an embodiment illustrated in FIGS. 2-5 below, compression of the suspension component may selectively permit and restrict fluid communication between two or more positive air chambers. For example, two positive air chambers may be compressed during a first portion of a compression stroke of a suspension component, while only one of those two positive air chambers is compressed during a second portion of the compression stroke. Such an arrangement may be used to facilitate an increasing rate or relatively progressive ramp up of the spring rate of the suspension component by decreasing the active volume of the positive air chambers.

Packaging constraints play a role in implementing an arrangement of positive and negative air chambers. As will be discussed in greater detail below, at least part of a positive air chamber may be provided radially outward and/or concentrically around another positive air chamber. To provide greater volume to the radially outer positive air chamber, this chamber may be extended axially above or below the other positive air chamber. These arrangements may require various additional features to satisfactorily implement within given packaging constraints.

As further features such as additional positive air chambers are provided, a given suspension component may have restricted space for further features. For example, as described directly below, a supplemental volume disposed between upper and lower suspension elements (also referred to generally as a casting volume) may be impacted by the inclusion of one or more additional positive air chambers. In various examples, one or more features may be provided to account for volume occupied by additional positive air chambers.

The upper tube and the lower tube of each leg define an interior region that is typically sealed. In particular, the top end of the upper tube is sealed, the bottom end of the lower tube is sealed, and a wiper seal is disposed between the upper and lower tubes. This helps to keep outside contaminants (e.g., dirt, debris) from entering the interior region of the leg, as well as help retain oil or other lubricant (e.g., grease) in the interior region. Therefore, a volume of air is contained within the sealed interior region and, specifically, within the lower tube. This air is distinct from fluid volumes in the damper or spring systems. This fluid volume sealed between the lower tube and the upper tube by the wiper seal is sometimes referred to as the casting volume. The air sealed in this interior region in the lower tube is typically at atmospheric pressure when the front fork is in the expanded or relaxed state. When the front fork is compressed, the upper tube is pushed into the lower tube, which decreases the volume in the lower tube. This causes an increase in pressure of the air in the lower tube. This increased pressure acts as an air spring, sometimes referred to as a casting ramp spring, which applies force to expand the upper and lower tubes back to their expanded positions. Therefore, the spring components of known front fork suspensions can include a positive spring, a negative spring, and a casting ramp spring. The casting ramp spring is generally formed by the telescoping nature of a fork in combination with the wiper seal implemented to keep out contaminants. The force generated by the casting ramp spring in the lower tube affects or impacts the spring rate of the spring, as well as creates a higher breakaway force needed to compress the fork. Further, the wiper seal is exposed to the elements to a higher degree than internal spring seals and thus the casting ramp spring is not as predictable as a dedicated spring due to wear or contamination affecting a sealing capability of the wiper seal.

Disclosed herein are example suspension components with increased internal air volume. In an example, the increased internal air volume is an increased air volume in a lower leg of a front fork, for example an increased casting volume (e.g., an overall casting volume capacity or air capacity) and/or improved compression ratio. Increasing a casting volume capacity can improve spring performance of a suspension component at least by relying more on a dedicated spring system and less on the less reliable casting volume spring. In particular, because the casting air volume capacity is increased, the forces generated by the casting ramp spring during compression are reduced and, thus, have less of an influence on the suspension component.

Examples disclosed herein provide an overall casting volume capacity within a suspension component such as a front fork or rear shock. For example, a front fork includes an upper tube and a lower tube. Example upper tubes disclosed herein a first end and a second end opposite the first end, and the lower tube has a third end and a fourth end opposite the third end. The upper tube extends into the third end of the lower tube to provide a telescopic arrangement along an axis. A seal is coupled to the lower tube adjacent to the third end of the lower tube. The seal forms a sealed residual air space within the lower tube, where the sealed residual air space defines or provides a casting volume capacity (e.g., a total casting volume capacity or cavity).

To provide a casting volume capacity of a suspension system, some example front forks disclosed herein can include a casting cavity or housing together with a lower leg of a front fork. In some examples, the housing can be constructed (e.g., formed via casting) with the lower leg and/or the front fork. In some examples, one or more removable plugs, caps or other fasteners can be coupled to the lower leg and/or the housing. The housing contributes to a casting volume capacity (e.g., a total expansion capacity) of the lower leg, which reduces instances of pressure spikes during a compression of the suspension.

As used herein, a casting volume capacity or a sealed residual air space means a total fixed volume or a non-expanding volume. In other words, a casting volume capacity or a sealed residual space disclosed herein is defined by one or more cavities defined by one or more walls of a structure. Extension or expansion cavities or chambers disclosed herein means that the extension chambers contribute to a total volume capacity (e.g., a total casting volume capacity) or a closed, fixed volume of a suspension component (e.g., to restrict pressure increases or pressure spikes in the closed volume). The casting volume capacity and/or a sealed residual space disclosed herein can be provided by a plurality of internal regions or cavities or can be provided by varying a dimension (e.g., a diameter or area) of a lower tube of a fork suspension.

In an embodiment, a lower housing or casting may include an increased supplementary or casting volume in a space radially outward of a space defined by a tube inserted into the casting. For example, the radially outward space may be increased in a perpendicular cross section of the lower taken below a bushing when compared to a radially outward space of a perpendicular cross section taken above a bushing.

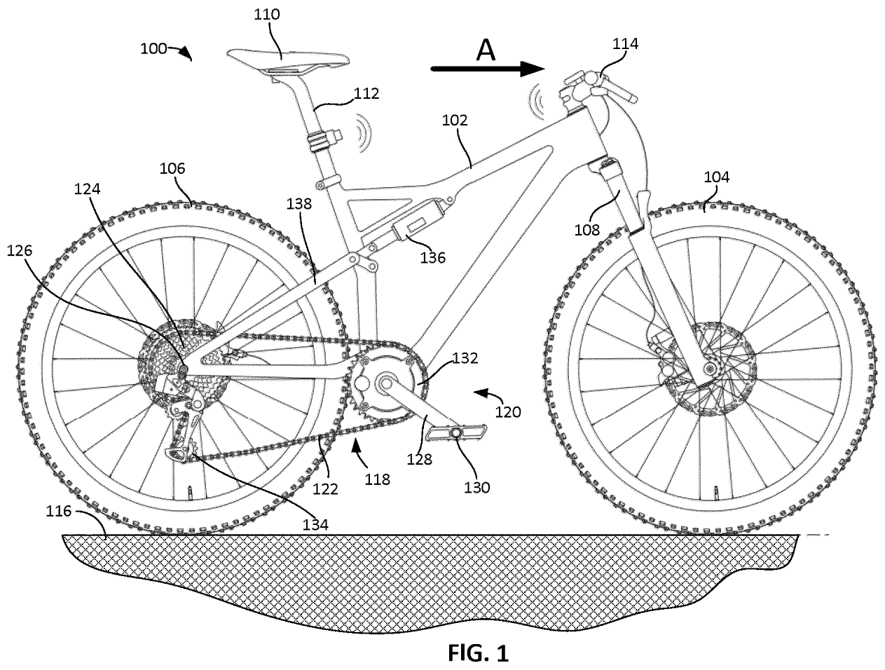

Turning now to the figures, FIG. 1 illustrates one example of a human powered vehicle on which the example front forks disclosed herein may be implemented. In this example, the vehicle is one possible type of bicycle 100, such as a mountain bicycle. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 108. A front and/or forward riding direction or orientation of the bicycle 100 is indicated by the direction of the arrow A in FIG. 1. As such, a forward direction of movement for the bicycle 100 is indicated by the direction of arrow A.

In the illustrated example of FIG. 1, the bicycle 100 includes a seat 110 coupled to the frame 102 (e.g., near the rear end of the frame 102 relative to the forward direction A) via a seatpost 112. The bicycle 100 also includes handlebars 114 coupled to the front fork 108 (e.g., near a forward end of the frame 102 relative to the forward direction A) for steering the bicycle 100. The bicycle 100 is shown on a riding surface 116. The riding surface 116 may be any riding surface such as the ground (e.g., a dirt path, a sidewalk, a street, etc.), a man-made structure above the ground (e.g., a wooden ramp), and/or any other surface.

In the illustrated example, the bicycle 100 has a drivetrain 118 that includes a crank assembly 120. The crank assembly 120 is operatively coupled via a chain 122 to a sprocket assembly 124 mounted to a hub 126 of the rear wheel 106. The crank assembly 120 includes at least one, and typically two, crank arms 128 and pedals 130, along with at least one front sprocket, or chainring 132. A rear gear change device 134, such as a derailleur, is disposed at the rear wheel 106 to move the chain 122 through different sprockets of the sprocket assembly 124. Additionally or alternatively, the bicycle 100 may include a front gear change device (not shown) to move the chain 122 through gears on the chainring 132.

The example bicycle 100 includes a suspension system having one or more suspension components. In this example, the front fork 108 is implemented as a front suspension component. The front fork 108 is or integrates a shock absorber that includes a spring and a damper, disclosed in further detail herein. Further, in the illustrated example, the bicycle 100 includes a rear suspension component 136, which is a shock absorber, referred to herein as the rear shock absorber 136. The rear shock absorber 136 is coupled between two portions of the frame 102, including a rear triangle, also referred to herein as a swing arm 138 coupled to the rear wheel 106. The front fork 108 and the rear shock absorber 136 absorb shocks and vibrations while riding the bicycle 100 (e.g., when riding over rough terrain). In other embodiments, the front fork 108 and/or the rear shock absorber 136 may be integrated into the bicycle 100 in other configurations or arrangements. Further, in other embodiments, the suspension system may employ only one suspension component (e.g., only the front fork 108) or more than two suspension components (e.g., an additional suspension component on the seat post 112) in addition to or as an alternative to the front fork 108 and rear shock absorber 136.

While the example bicycle 100 depicted in FIG. 1 is a type of mountain bicycle, the example front forks (and/or lower housings or housings) disclosed herein can be implemented on other types of bicycles. For example, the disclosed front forks may be used on road bicycles, as well as bicycles with mechanical (e.g., cable, hydraulic, pneumatic, etc.) and non-mechanical (e.g., wired, wireless) drive systems. The disclosed front forks can also be implemented on other types of two-wheeled, three-wheeled, and four-wheeled human powered vehicles. Further, the example front forks can be used on other types of vehicles, such as motorized vehicles (e.g., a motorcycle, a car, a truck, etc.).

Turning now to FIG. 2, a schematic sectional view of a suspension component 300 is shown in an extended position. The extended position of FIG. 2 may represent a mechanically fully extended position, a “sag” position accounting for static rider weight, or a fully extended position in which force from positive and negative air springs are at equilibrium.

The schematic example of the suspension component 300 depicted in FIGS. 2-5 generally includes a suspension body 302 throughout which a piston 304 is configured to travel. For example, the piston 304 may be sized and shaped to seal against one or more walls of the suspension body 302 to form one or more suspension chambers as discussed in greater detail below. The piston 304 includes at least one seal, and as shown includes a first piston seal 312 and a second piston seal 313. The first piston seal 312 and the second piston seal 313 may each be configured as O-ring seals, square seals, or any other suitable seal type. The first piston seal 312 and the second piston seal 313 are generally configured to maintain a seal as the piston 304 travels along an axis B, either in a compression direction C or opposite the compression direction C (i.e. in a rebound or extension direction).

The piston 304, with the first piston seal 312 and the second piston seal 313, generally seals a first positive chamber 306 from a negative chamber 310. As shown in FIGS. 2-5, the piston may be configured with a piston chamber 308. In the depicted example, the piston chamber 308 cooperates with the first positive chamber 306 to effectively increase a volume of the first positive chamber 306. However, it should also be appreciated that the piston chamber 308 could instead cooperate with the negative chamber 310 to effectively increase a volume of the negative chamber 310. As will be described in greater detail below, the depicted arrangement of the piston 304 may provide an advantageous elongation such that a sealing position is achieved while retaining a desired minimum effective volume of the first positive chamber 306 by incorporating the piston chamber 308 into the elongate example of the piston 304.

It is contemplated herein that the first piston seal 312 and the second piston seal 313 may selectively facilitate a non-sealing relationship. For example, a non-sealing relationship may be provided at a given travel or range of travel of the piston 304 along the axis B. Turning now to FIG. 3, a first movement of the piston 304 in the compression direction C along the axis B facilitates operation of a bypass device 333. The state of FIG. 3 may be referred to herein as a first compressed position. As shown in FIG. 3, the bypass device 333 generally comprises a first bypass feature 332 and a second bypass feature 330. In the depicted example, the first bypass feature 332 is configured to selectively bypass fluid past the first piston seal 312 and the second bypass feature 330 is configured to selectively bypass fluid past the second piston seal 313. The first bypass feature 332 and the second bypass feature 330 as shown are generally configured as a dimple or notch, and may be cast, formed, machined, or otherwise provided in the suspension body 302. It should also be appreciated that additional configurations may be provided, such as external tubing or other routing of the first bypass feature 332 and/or the second bypass feature 330 to facilitate fluid communication past the first piston seal 312 and/or the second piston seal 313.

As shown in FIG. 3, the first bypass feature 332 is spaced apart from the second bypass feature 330 along the axis B. In some embodiments, including that depicted in FIG. 3, the first bypass feature 332 may be spaced apart from the second bypass feature 330 along the axis B by approximately the same distance as the first piston seal 312 is spaced apart from the second piston seal 313 along the axis B, for example within a margin of 1, 2, 5, 10, or 25 percent. It is generally contemplated that the complementary arrangements of the first bypass feature 332 and the second bypass feature 330 and the first piston seal 312 and the second piston seal 313 allow immediate fluid communication between the first positive chamber 306 and the negative chamber 310, as shown in FIG. 3. However, it is also contemplated that an arrangement of seals and bypass features may provide a staggered or offset bypass of fluid. For example, the first bypass feature 332 may facilitate fluid communication up to the second piston seal 313, then once the first bypass feature 332 has stopped fluid communication, the second bypass feature 330 may then facilitate fluid communication to the negative chamber 310. Fluid transfer and pressure compensation or equalization may still occur in a process that may be referred to as shuttling.

Returning to the example shown in FIG. 3, the first bypass feature 332 and the second bypass feature 330 cooperate to selectively permit fluid communication between the first positive chamber 306 and the negative chamber 310. As the piston 304 moves beyond the position shown in FIG. 3 along the axis B in either direction, fluid communication between the first positive chamber 306 and the negative chamber 310 is cut off. For example, from the position of FIG. 3., the piston 304 may move to first end position as shown in FIG. 2 and defined by the first bypass feature 332 being disposed beyond the first piston seal 312 and the second seal 313 along the axis B in the compression direction C and the second bypass feature being disposed between the first piston seal 312 and the second piston seal 313 along the axis B. In this first end position of FIG. 2, the negative chamber 310 is reduced in volume relative to the bypass position shown in FIG. 3, and thus a relatively high pressure is achieved in the negative chamber 310 relative to the first positive chamber 306. However, the first end position of FIG. 2 may still represent an equilibrium position between the first positive chamber 306 and the negative chamber 310 at least because a working area of the piston 304 in the negative chamber 310 is relatively small compared to a working area of the piston 304 in the first positive chamber 306. The working area of the piston 304 in the negative chamber 310 is relatively small at least in part to account for a piston shaft 314.

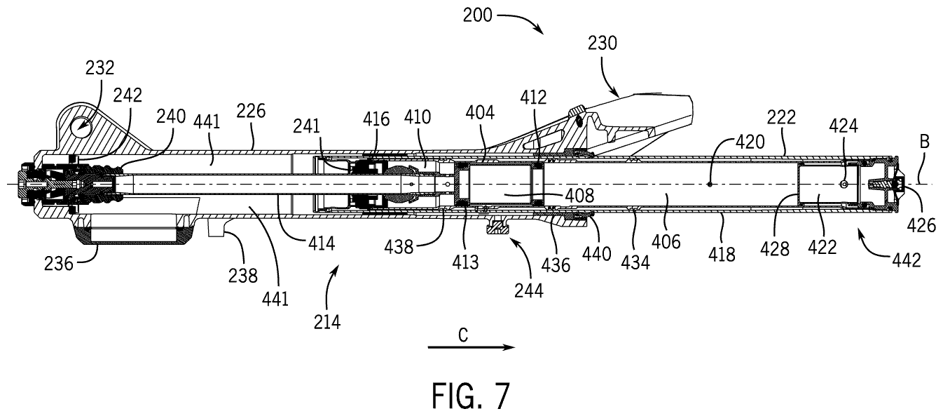

Still referring to FIGS. 2-5, the piston shaft 314 is generally provided to connect the piston to other components of a bicycle. For example, the piston shaft 314 may connect to a lower tube of a front fork (see, e.g. FIG. 7) while the suspension body 302 connects to an upper tube of the same front fork. It is also contemplated that the piston shaft 314 and suspension body 302 may connect to opposite ends of such a front fork, or either end of a rear shock or a seatpost. As shown in FIG. 2, the piston shaft 314 cooperates with a shaft seal 316 to maintain the negative chamber 310. The shaft seal 316 may be provided as an O-ring seal, a square seal, or any other suitable type of seal. It should be appreciated that the sectional area of the piston shaft 314 reduces the working area of the negative chamber on the piston 304 as described above.

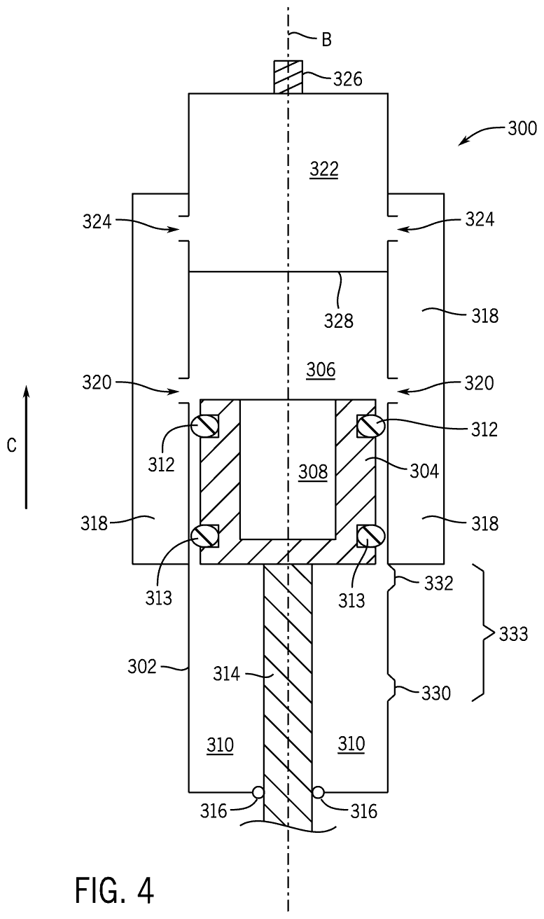

Turning now to FIG. 4, a second compressed position is shown where the piston 304 has passed the bypass device 333. Although as shown in FIG. 4 that the second piston seal 313 has passed the first bypass feature 332 in the compression direction C along the axis B, it should be appreciated that a generally similar fluid communication path may be defined with the second piston seal 313 below the first bypass feature 332 in the compression direction C so long as the first piston seal 312 is above the first bypass feature 332 in the compression direction C. However, FIG. 4 depicts the specific state known as an end state of the bypass device 333 wherein both the first piston seal 312 and the second piston seal 313 are disposed beyond each of the first bypass feature 332 and the second bypass feature 330 along the axis B in the compression direction C.

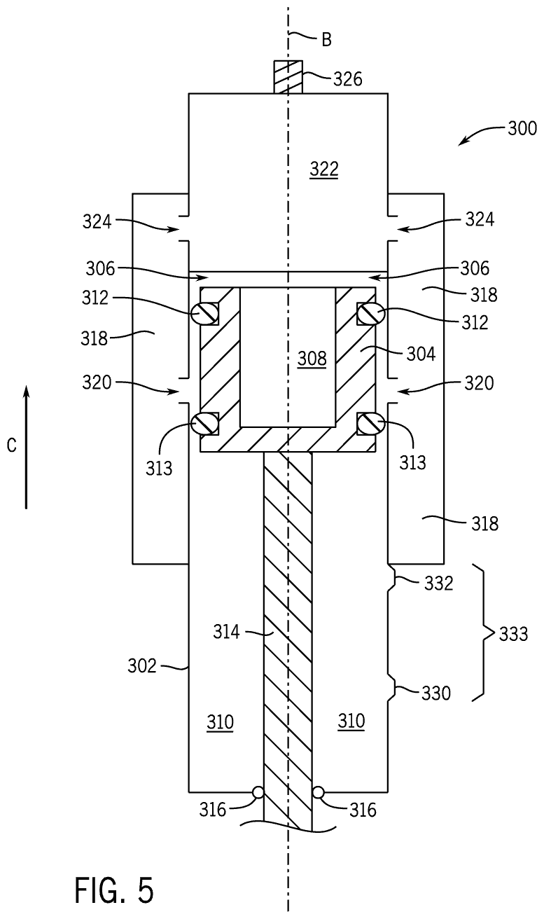

In the position of FIG. 4, a second positive chamber 318 is in fluid communication with the first positive chamber 306 through a first positive chamber passage 320. A third positive chamber 322 is provided in FIG. 4, the third positive chamber 322 in fluid communication with the second positive chamber 318 through a second positive chamber passage 324. As will be shown between FIGS. 4 and 5, the first positive chamber 306 is in selective fluid communication with the second positive chamber 318 through the first positive chamber passage 320. This selective fluid communication can be controlled by the position of the piston 304 using at least the first piston seal 312. For example, FIG. 5 depicts the first piston seal 312 preventing fluid communication between the first positive chamber 306 and the second positive chamber 318. It should also be noted in the example and position shown in FIG. 5 that the second piston seal 313 is operable to prevent fluid communication between the second positive chamber 318 and the negative chamber 310.

Turning back to FIG. 4, the second positive chamber 318 in this example is always in fluid communication with the third positive chamber 320 through the second positive chamber passage 324. However, it is also contemplated that fluid communication from the first positive chamber 306 to the third positive chamber 320 may be independently selectively controlled, for example by providing a chamber passage (not shown) in the suspension body further along the axis B in the compression direction C such that the first piston seal 312 selectively controls fluid communication therethrough from the first positive chamber 306.

Turning to FIG. 5, in the depicted state and position of the piston 304 where the first positive chamber 306 is separated or cut off from fluid communication with the second positive chamber 318 and the third positive chamber 322, the volume acted on by movement of the piston 304 in the compression direction C is reduced. As the volume acted on by the piston 304 in compression reduces from a combined volume of the first positive chamber 306 (including the piston chamber 308), the second positive chamber 318, and the third positive chamber 322 to a volume of only the first positive chamber 306 (including the piston chamber 308), the rate of rise of the effective spring rate in compression is increased. As discussed above, an air spring generally has a rising rate as the effective volume decreases. The example described herein provides a first rising spring rate until the first piston seal 312 prevents fluid communication between the first positive chamber 306 and the second positive chamber 318, then a second rising spring rate from that point on during further movement of the piston 304 in the compression direction C along the axis B. Accordingly, spring rate can be tuned and controlled based on position of the piston 304. In such a position dependent air spring configuration, it may be advantageous to have a relatively low spring rate in the first part of the travel of the piston 304 in the compression direction C to provide suppleness to the rider while providing a relatively high spring rate in the second part of the travel of the piston 304 in the compression direction C to prevent a harsh mechanical bottom out.

The combined spring rate ramp determined by compression with the piston 304 of the volume of the first positive chamber 306, the second positive chamber 318, and the third positive chamber 322 may have a relatively slow increasing rate (i.e. a relatively linear spring) in comparison to the relatively fast increasing rate (i.e. a relatively progressive spring) determined by compression with the piston 304 of the volume of only the first positive chamber 306. Accordingly, the suspension component 300 may be tuned to have a relatively linear spring rate during a portion of its travel in compression. This tuning of the suspension component 300 may be used to provide a predictable support and relatively linear feel for a rider, while maintaining bottom out protection with the relatively progressive spring rate in the later portion of travel in compression.

In some embodiments, the relatively linear spring rate accounts for the majority of the travel of the suspension component 300. For example, the suspension component 300 may be arranged such that the first piston seal 312 does not pass the first positive chamber passage 320 (thus sealing the first positive chamber 306 from the second positive chamber 318 and the third positive chamber 322) until the piston 304 has travelled half of its maximum distance from the extended position shown in FIG. 2 to the fully compressed position shown in FIG. 5. In some embodiments, the piston 304 will not seal the first positive chamber 306 from additional positive volume such as the second positive chamber 318 and the second positive chamber 320 until the piston 304 has travelled more than 60%-95% of its maximum travel distance in the compression direction C. In an embodiment, the piston 304 may provide this positive chamber sealing effect at approximately 75% of its maximum travel distance in the compression direction C.

As described above, various packaging constraints may determine possible configurations of the suspension component 300. For example, the elongated configuration of the piston 304 depicted in FIGS. 2-5 may be provided such that the first seal 312 reaches the first positive chamber passage 320 at a desired travel position. In this example, the piston 304 is configured with the piston chamber 308, which may provide a desired volume in the first positive chamber 306 while still allowing a relatively compact configuration where the piston 304 approaches a mechanical constraint on its travel as shown with the piston 304 approaching a positive chamber wall 328 in FIG. 5.

The arrangement of the second positive chamber 318 and the third positive chamber 322 may also be constrained based on packaging requirements. For example, a maximum width or radial dimension based on the axis B may constrain the volume of the second positive chamber 318. Accordingly, if a greater volume is desired, for example to provide a more linear spring rate as described above, then the third positive chamber 322 may be provided such that it at least in part overlaps the first positive chamber 306 in a radial dimension relative to the axis B. With such a configuration, the maximum radial dimension can be controlled while still providing extra volume beyond the first positive chamber 306. For example, the third positive chamber 322 may be disposed at least in part above the first positive chamber 306 in the compression direction C. In some embodiments, a majority of the third positive chamber 322 is disposed overlapping the first positive chamber 306 in the radial dimension relative to the axis B. As shown in FIGS. 2-5, the third positive chamber 322 may entirely overlap the first positive chamber 306 in the radial dimension relative to the axis B and may be disposed entirely above the first positive chamber 306 in the compression direction C.

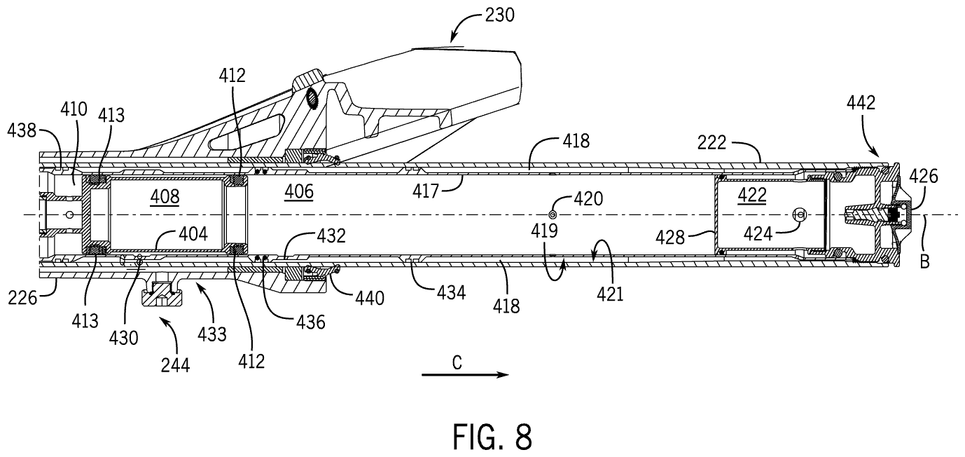

Still referring to FIGS. 2-5, the positive chamber wall 328 may be provided to at least in part separate the first positive chamber 306 from the third positive chamber 322. For example, as shown in the example of FIGS. 2-5, the positive chamber wall 328 may represent a total working area of the piston 304, a maximum radial dimension of the first positive chamber 306, and a maximum radial dimension of the third positive chamber 322. In some embodiments, the first positive chamber 306 and the third positive chamber 322 may be defined within the same radial constraint, for example in a tube configuration of the suspension body 302 as shown in FIGS. 2-5. The positive chamber wall 328 may be provided as a fixed wall that is co-formed, welded in, or otherwise attached within the suspension body 302. Alternatively, the positive chamber wall 328 may be a removable or non-removable insert. For example, the positive chamber wall 328 may be part of a removable insert as described in greater detail with reference to FIGS. 7 and 8 below.

The second positive chamber 318 may be disposed at least partially radially outward of the first positive chamber 306 and/or the third positive chamber 322 relative to the axis B. For example, the second positive chamber 318 may be configured to occupy a maximum constrained radial space outward of the first positive chamber 306 and/or the third positive chamber 322. As shown in FIGS. 2-5, the second positive chamber 318 partially overlaps each of the first positive chamber 306 and the third positive chamber 322 relative to the axis B. It should also be appreciated that this axial overlap may be complete in some embodiments, for example with the second positive chamber 318 disposed radially outward from and axially overlapping the full axial extent of the first positive chamber 306 and/or the third positive chamber 322 relative to the axis B.

An adjustment valve 326 may be provided to adjust pressures in one or more of the described pressure chambers. For example, referring still to the example of FIGS. 2-5, the adjustment valve 326 is operable to adjust pressures in the third positive chamber 322, the second positive chamber 318 through the second positive chamber passage 324, the first positive chamber 306 through the first positive chamber passage 320, and the negative chamber 310 through the bypass device 333. It should also be appreciated that one or more additional adjustment valves (not shown) may also be provided to adjust pressures independently, for example in an embodiment where the negative chamber 310 is never in fluid communication with the first positive chamber 306. However, referring to the example of FIGS. 2-5, the suspension component 300 can be configured such that desired relative pressures between each of the pressure chambers can be achieved with a single pressure adjustment through the adjustment valve 326. For example, pressure can be adjusted with the adjustment valve 326 at the state shown in FIG. 3 when the negative chamber 310, the first positive chamber 306, the second positive chamber 318, and the third positive chamber 322 are in fluid communication with one another. Pressure could also be adjusted with the adjustment valve 326 at a different position, such as that shown in FIG. 2, the suspension component 300 cycled to achieve an equilibrium pressure between the first positive chamber 306 and the negative chamber 310, then the pressure checked and adjusted through the adjustment valve 326 again if desired.

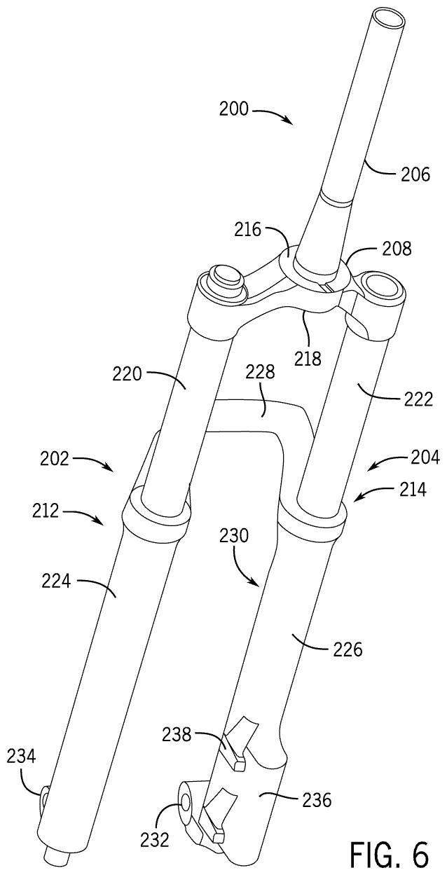

Turning now to FIG. 6, an example front fork 200 (e.g., a suspension component) is shown in a perspective rear view. The example front fork may be implemented as the front fork 108 on the bicycle 100 of FIG. 1. In the illustrated example of FIG. 2, the front fork 200 includes a steerer tube 206, a crown 208, a first leg 212, and a second leg 214. The crown 208 has a top side 216 and a bottom side 218 opposite the top side 216. The steerer tube 206 is coupled to the crown 208 and extends outward (e.g., upward) from the top side 216 of the crown 208. The steerer tube 206 is to be inserted through a neck tube on the frame 102 (FIG. 1) of the bicycle and coupled to the handlebars 114 (FIG. 1). The steerer tube 206 can be tapered or straight. In some embodiments, the steerer tube 206 is constructed of aluminum or carbon fiber. In other embodiments, the steerer tube 206 can be constructed of other materials. The first and second legs 212, 214 are coupled to the crown 208 and extend outward (e.g., downward) from the bottom side 218 of the crown 208. The first and second legs 212, 214 are to be coupled to the front wheel 104 (FIG. 1). In the illustrated example, the first leg 212 is spaced from the second leg 214. The fork configuration shown in FIG. 6 is often referred to as a single crown fork, but it should be appreciated that dual crown or other configurations of forks could apply the same or similar features of the suspension components described herein.

In the illustrated embodiment, the first and second legs 212, 214 include first and second upper tubes 220, 222, respectively, and first and second lower tubes 224, 226, respectively. The first and second upper and lower tubes 220, 222, 224, 226 are sometimes referred to as stanchions or leg portions. The first and second upper tubes 220, 222 are coupled to the crown 208. The front fork 200 includes an arch 228 (sometimes referred to as a fork brace or stabilizer) coupled between the first and second lower tubes 224, 226. As used herein, the first and second lower tubes 224, 226 and the arch 228 are referred to as a lower housing 230, and which may also be referred to as a lower tube assembly. In some embodiments, the lower housing 230 (i.e., the lower including first and second lower tubes 224, 226 and the arch 228) is constructed as a single part or component (e.g., a monolithic structure), such as from a one-piece casting (e.g., from metal such as aluminum) or a one-piece carbon fiber structure. In some embodiments, the lower housing 230 or may be constructed as separate first and second lower tubes 224, 226 that are coupled together (e.g., via welding, via threaded fasteners, etc.) by the arch 228. The first and second lower tubes 224, 226 include respective front wheel attachment portions or flanges 232, 234, having holes (e.g., eyelets) or dropouts, for attaching the front wheel 104 (FIG. 1) to the front fork 200.

The first and second upper tubes 220, 222 are slidably received within the respective first and second lower tubes 224, 226. Thus, the first and second upper tubes 220, 222 form a telescopic arrangement with the respective first and second lower tubes 224, 226. During a compression stroke, the first and second upper tubes 220, 222 move into or toward the respective first and second lower tubes 224, 226, and during a rebound stroke, the first and second upper tubes 220, 222 move out of or away from the respective first and second lower tubes 224, 226. The front fork 200 includes a damper 202 and a spring 204. In this example, the damper 202 is integrated into and/or otherwise formed at least partially by the first leg 212, and the spring 204 is integrated into and/or otherwise formed at least partially by the second leg 214. The damper 202 and the spring 204 are disclosed in further detail herein.

In the illustrated example of FIG. 6, the lower housing 230 of the front fork 200 includes a supplemental chamber 236 defining a supplemental volume therein. In particular, in this example, the supplemental chamber 236 is formed on the second lower tube 226. Specifically, the supplemental chamber 236 of the illustrated example protrudes or projects from an outer surface of the second lower tube 226. As described in greater detail below, the supplemental chamber 236 contributes to an internal volume (e.g., a total volume capacity, a casting volume, an air volume, a sealed residual air space, etc.) of the second lower tube 226 to mitigate and/or reduce effects of casting ramp spring (e.g., casting ramp behavior) during compression of the front fork 200. In other words, the supplemental chamber 236 contributes to an overall volume capacity of the lower housing 230 (e.g., to provide a larger air volume during compression of the front fork 200). For example, the supplemental chamber 236 may be employed at least in part to provide supplemental volume occupied by a configuration as described with reference to the suspension component 300 of FIGS. 2-5 described above. Although not shown, in some embodiments, the first lower tube 224 can also include a supplemental chamber similar to the supplemental chamber 236. In some embodiments, the first lower tube 224 and the second lower tube 226 include a supplemental chamber having a different design or shape.

While the example front fork 200 of FIG. 6 includes two legs, in other embodiments, the front fork 200 can be configured as a single-side fork that only includes one of the legs. In such an embodiment, the single leg may include a damper, a spring, or a combination spring and damper. Additionally or alternatively, the fork may be provided in an inverted configuration, where the lower leg(s) telescopes within the upper leg(s).

To mitigate or reduce the casting ramp spring effect noted above, the lower housing 230 of the front fork 200 of the illustrated example includes the supplemental chamber 236. Specifically, the supplemental chamber 236 of the illustrated example increases a volume capacity (e.g., volume of air capacity) of the second lower tube 226 of the front fork 200. Expanding the volume capacity of the second lower tube 226 reduces instances of pressure increases or pressure spikes in the interior region during compression cycle. The supplemental chamber 236 provides an additional or increased volume capacity of the front fork to reduce (e.g., minimize) an amount of pressure increase during a compression cycle of the front fork 200 (e.g., compared to a front fork without the additional volume capacity provided by the supplemental chamber 236). While the supplemental chamber 236 is described in connection with the second lower tube 226, which is part of the leg with the spring 204, the front fork 200 may include a similar supplemental chamber on the first lower tube 224 that is part of the leg with the damper 202. Therefore, any of the example aspects discussed in connection with the supplemental chamber 236 can likewise apply to a housing on the first lower tube 224.

Turning now to FIG. 7, a partial sectional view of the front fork 200 of FIG. 6 is provided. Specifically, the second leg 214 with the second upper tube 222 and the second lower tube 226 is shown in greater detail. A crown mounting portion 442 is provided where the second upper tube 222 may be mounted to a crown (not shown) as described above with reference to FIG. 6. The second leg 214 as shown includes a brake mounting feature 238. The brake mounting feature 238 provides for mounting a brake caliper (not shown) and may be configured to accommodate the supplemental chamber 236, which may similarly be configured to accommodate the brake mounting feature 238. Although the supplemental chamber 236 and the brake mounting feature 238 are shown on the second leg 214, it should be appreciated that the supplemental chamber 236 and/or the brake mounting feature 238 may be incorporated on the first leg 212 as shown in FIG. 6 in addition or as an alternative to such inclusion on the second leg 214. Similarly, it should be noted that the spring 204 and the damper 202 may be incorporated on opposite ones of the first leg 212 and the second leg 214 as shown in FIG. 6 or may be combined into one or both of the first leg 212 and the second leg 214.

Continuing with FIG. 7, jounce bumper 240 and a bottom out bumper 242 are also provided. The bottom out bumper 242 as shown serves to cushion a mechanical bottom out where the second upper tube would otherwise potentially impact a hard stop. The bottom out bumper 242 may be tuned with a relatively high spring rate elastomeric material to dissipate a potentially large amount of force before full compression. The jounce bumper 240 is provided such that a jounce feature 241 cooperates with the jounce bumper 240 to provide a low spring rate elastomeric material relative to the bottom out bumper 242 but with a relatively high spring rate compared with the air spring configuration to serve as an intermediate spring between the air spring and the bottom out bumper 242.

Still referring to FIG. 7, a configuration with multiple positive chambers as described above with reference to FIGS. 2-5 may be provided. It should be appreciated that features from the examples of FIGS. 2-5 may be provided wholesale or in any combination in the example of FIG. 7 or vice versa and that each example may provide distinct features. As shown in FIG. 7, a piston 404 is provided slidably housed within the second upper tube 222. The piston 404 includes a piston chamber 408 to cooperate with a first positive chamber 406. A negative chamber 410 is provided opposite the piston chamber 408 and the first positive chamber 406. The first positive chamber 406 may be sealed from the negative chamber 410 by at least one sealing element. For example, as shown in FIG. 7, a first piston seal 412 and a second piston seal 413 are provided on the piston 404. The first piston seal 412 and the second piston seal 413 may include any number or type of sealing elements, including any combination of O-ring seal, four-way seal, X-ring seal, wiper seal, or backup seal.

The piston 404 in FIG. 7 is controlled at least in part by a piston shaft 414 attached to the second lower tube 226. However, it should also be appreciated that the piston shaft 414 could be attached instead to the second upper tube 222, for example in an inverted configuration from that shown in FIG. 7. The piston shaft 414 is movable past a shaft seal 416, which in this example serves to seal the negative chamber 410 from a supplemental volume 441. The supplemental volume 441, as described above, is generally maintained at atmospheric pressure in a rest position of the front fork 200. A supplemental volume seal 440 is provided generally to maintain a sealed internal environment, keeping lubricants in and contaminants out. A chamber vent 244 is further provided to facilitate selective communication between the supplemental volume 441 and atmosphere. For example, a user may operate the chamber vent 244 to equalize the supplemental volume with atmospheric pressure following a change in atmospheric pressure (e.g. from a change in altitude). The supplemental chamber 236 shown in FIG. 7 effectively increases the volume of the supplemental volume 441. For example, the supplemental chamber 236 may account for additional volume used in air spring configurations discussed herein by providing volume that otherwise may exist within the supplemental volume 441.

Turning now to FIG. 8, an enlarged partial view of the sectional view of FIG. 7 is provided. A bypass device 433 is shown in FIG. 8 to include a first bypass feature 432 and a second bypass feature 430. The first bypass feature 432 is configured to cooperate with the first piston seal 412 and the second bypass feature 430 is configured to cooperate with the second piston seal 413, for example as described above with reference to the examples of FIGS. 2-5. The bypass device 433 is operable to control relative pressures between the first positive chamber 406 and the negative chamber 410 through a single embodiment of an adjustment valve 426, for example as described above with reference to the examples of FIGS. 2-5.

Continuing with the example of FIG. 8, a second positive chamber 418 is provided in selective fluid communication with the first positive chamber 406 through a first positive chamber passage 420. As shown, the second positive chamber 418 is disposed radially (with reference to axis B) between an sleeve outer wall 419 of a sleeve 417 and a second upper tube inner wall 421 of the second upper tube 222. The sleeve 417 may be provided to contain the positive chamber 418, the piston 404, and various other chambers and components as described in greater detail below. As shown, the second positive chamber 418 is disposed radially outward of the first positive chamber 406. The second positive chamber 418 may be constrained in volume at least in part by one or more chamber seals. For example, a second positive chamber first seal 434, a second positive chamber second seal 436, and/or a second positive chamber third seal 438 may be provided. The sleeve 417 may be configured to accept any one of these seals 434, 436, 438, for example to allow user or installer tunability based on which seal is installed. For example, the greatest volume of the second positive chamber 418 may be achieved by only installing the third positive chamber seal 438, while a reduced volume of the second positive chamber 418 may be achieved by installing the second positive chamber seal 436, and a yet further reduced volume of the second positive chamber 418 may be achieved by installing the first positive chamber seal 434.

Still referring to the example of FIG. 8, communication between the first positive chamber 406 and the second positive chamber 418 may be controlled by travel of the piston 404, for example as described above with reference to the examples of FIGS. 2-5. As the piston 404 travels relative to the second upper tube 222 in the compression direction C, the first piston seal 412 will prevent fluid communication between the first positive chamber 406 and the second positive chamber 418 through the first positive chamber passage 420. Similarly, once such a position is achieved, the second piston seal 413 will prevent fluid communication between the second positive chamber 418 and the negative chamber 410 through the first positive chamber passage 420. Although the first positive chamber passage 420 is shown in a port configuration, it should be appreciated that various openings, slots, channels, tubes, or other passages may be used to provide selective communication between the first positive chamber 406 and the second positive chamber 418.

In the example of FIG. 8, a third positive chamber 422 is provided in fluid communication with the second positive chamber 418 through a second positive chamber passage 424. The second positive chamber passage 424 may generally be configured as described with reference to FIGS. 2-5 above. In the example of FIG. 8, the third positive chamber 422 is separated from the first positive chamber 406 by a positive chamber wall 428. As shown, the positive chamber wall 428 is removably inserted into the second upper tube 222 and the sleeve 417. Although not shown, it should be appreciated that various volume spacers may be included, for example with installation of the positive chamber wall 428. In one example, a volume spacer may be added above the positive chamber wall 428 in the compression direction C to reduce volume of the third positive chamber 422 and/or a volume spacer may be added below the positive chamber wall 428 in the compression direction C to reduce volume of the first positive chamber 406. In such a manner, effective positive volume during the first part of the travel and effective positive volume during all of the travel (and proportionally more during the final part of the travel) may be independently controlled.

The embodiments described herein may be provided with any of the features and elements as shown and described. The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

Further aspects are provided by the subject matter of the following clauses:

A suspension component for a bicycle, the suspension component comprising: a first positive chamber; a piston movable through the first positive chamber along an axis from a first position to a second position in a compression direction; a positive chamber passage in fluid communication with the first positive chamber with the piston in the first position, and separated from fluid communication with the first positive chamber with the piston in the second position; and a second positive chamber in fluid communication with the positive chamber passage, wherein the second positive chamber is disposed at least in part overlapping the first positive chamber in a radial dimension relative to the axis.

The suspension component of the preceding clause, wherein the second positive chamber is disposed at least in part above the first positive chamber in the compression direction.

The suspension component of any preceding clause, wherein the second positive chamber is separated from the first positive chamber in the compression direction by a positive chamber wall.

The suspension component of any preceding clause, wherein the positive chamber passage comprises a third positive chamber, the third positive chamber disposed radially outward of and at least partially overlapping in an axial dimension relative to the axis, each of the first positive chamber and the second positive chamber.

The suspension component of any preceding clause, further comprising a negative chamber separated by the piston from the first positive chamber.

The suspension component of any preceding clause, further comprising an adjustment valve, wherein the adjustment valve is operable to adjust pressures in the negative chamber, the first positive chamber, and the second positive chamber.

The suspension component of any preceding clause, wherein the piston comprises: a first piston seal; and a second piston seal spaced apart from the first piston seal along the axis.

The suspension component of any preceding clause, wherein in the second position: the first piston seal is disposed beyond the positive chamber passage in the compression direction; and the positive chamber passage is disposed beyond second piston seal in the compression direction.

The suspension component of any preceding clause, further comprising: a first bypass feature configured to selectively bypass fluid past the first piston seal; and a second bypass feature configured to selectively bypass fluid past the second piston seal, wherein the first bypass feature is spaced apart from the second bypass feature along the axis by approximately the same distance as the first piston seal is spaced apart from the second piston seal along the axis.

A suspension component for a bicycle, the suspension component comprising: a positive chamber; a negative chamber; a piston movable along an axis in a compression direction, the piston comprising: a first seal; and a second seal spaced apart from the first seal along the axis, wherein at least one of the first seal and the second seal is operable to fluidly separate the positive chamber and the negative chamber; a bypass device, the bypass device comprising: a first bypass feature; and a second bypass feature spaced apart from the first bypass feature along the axis, wherein the first bypass feature and the second bypass feature cooperate to selectively permit fluid communication between the positive chamber and the negative chamber throughout travel of the piston along the axis.

The suspension component of any preceding clause, wherein the first bypass feature is spaced apart from the second bypass feature along the axis by approximately the same distance as the first piston seal is spaced apart from the second piston seal along the axis.

The suspension component of any preceding clause, wherein a first end position of the piston is defined by: the first bypass feature being disposed beyond the first seal and the second seal along the axis in the compression direction; and the second bypass feature being disposed between the first seal and the second seal along the axis.

The suspension component of any preceding clause, wherein a second end position of the piston is defined by: the first seal being disposed beyond the first bypass feature and the second bypass feature along the axis in the compression direction; and the second seal being disposed beyond the first bypass feature and the second bypass feature along the axis in the compression direction.

The suspension component of any preceding clause, wherein the positive chamber comprises: a first positive chamber; a second positive chamber; and a positive chamber passage selectively permitting fluid communication between the first positive chamber and the second positive chamber based at least in part on a position of the piston along the axis.

The suspension component of any preceding clause, wherein the piston is movable along the axis in the compression direction to an end position wherein the first seal is disposed beyond the positive chamber passage in the compression direction, sealing the first positive chamber from the second positive chamber.

The suspension component of any preceding clause, wherein, in the end position, the positive chamber passage is disposed beyond the second seal along the axis in the compression direction.

The suspension component of any preceding clause, further comprising an adjustment valve, wherein the adjustment valve is operable to adjust pressures in the negative chamber, the first positive chamber, and the second positive chamber.

The suspension component of any preceding clause, wherein the suspension component is a front fork for a bicycle.

The suspension component of any preceding clause, wherein the suspension component is a rear shock for a bicycle.

The suspension component of any preceding clause, wherein the suspension component is a seatpost for a bicycle.

We claim:

1. A suspension component for a bicycle, the suspension component comprising:
a first positive chamber;
a piston movable through the first positive chamber along an axis from a first position to a second position in a compression direction;
a positive chamber passage in fluid communication with the first positive chamber with the piston in the first position, and separated from fluid communication with the first positive chamber with the piston in the second position; and
a second positive chamber in fluid communication with the positive chamber passage, wherein the second positive chamber is disposed at least in part overlapping the first positive chamber in a radial dimension relative to the axis.

2. The suspension component of claim 1, wherein the second positive chamber is disposed at least in part above the first positive chamber in the compression direction.

3. The suspension component of claim 2, wherein the second positive chamber is separated from the first positive chamber in the compression direction by a positive chamber wall.

4. The suspension component of claim 2, wherein the positive chamber passage comprises a third positive chamber, the third positive chamber disposed radially outward of and at least partially overlapping in an axial dimension relative to the axis, each of the first positive chamber and the second positive chamber.

5. The suspension component of claim 1, further comprising a negative chamber separated by the piston from the first positive chamber.

6. The suspension component of claim 5, further comprising an adjustment valve, wherein the adjustment valve is operable to adjust pressures in the negative chamber, the first positive chamber, and the second positive chamber.

7. The suspension component of claim 5, wherein the piston comprises:
a first piston seal; and
a second piston seal spaced apart from the first piston seal along the axis.

8. The suspension component of claim 7, wherein in the second position:
the first piston seal is disposed beyond the positive chamber passage in the compression direction; and
the positive chamber passage is disposed beyond second piston seal in the compression direction.

9. The suspension component of claim 7, further comprising:
a first bypass feature configured to selectively bypass fluid past the first piston seal; and
a second bypass feature configured to selectively bypass fluid past the second piston seal, wherein the first bypass feature is spaced apart from the second bypass feature along the axis by approximately the same distance as the first piston seal is spaced apart from the second piston seal along the axis.

10. A suspension component for a bicycle, the suspension component comprising:
a positive chamber;
a negative chamber;
a piston movable along an axis in a compression direction, the piston comprising:
a first seal; and
a second seal spaced apart from the first seal along the axis, wherein at least one of the first seal and the second seal is operable to fluidly separate the positive chamber and the negative chamber;
a bypass device, the bypass device comprising:
a first bypass feature; and
a second bypass feature spaced apart from the first bypass feature along the axis, wherein the first bypass feature and the second bypass feature cooperate to selectively permit fluid communication between the positive chamber and the negative chamber throughout travel of the piston along the axis.

11. The suspension component of claim 10, wherein the first bypass feature is spaced apart from the second bypass feature along the axis by approximately the same distance as the first piston seal is spaced apart from the second piston seal along the axis.

12. The suspension component of claim 10, wherein a first end position of the piston is defined by:
the first bypass feature being disposed beyond the first seal and the second seal along the axis in the compression direction; and
the second bypass feature being disposed between the first seal and the second seal along the axis.

13. The suspension component of claim 12, wherein a second end position of the piston is defined by:
the first seal being disposed beyond the first bypass feature and the second bypass feature along the axis in the compression direction; and
the second seal being disposed beyond the first bypass feature and the second bypass feature along the axis in the compression direction.

14. The suspension component of claim 10, wherein the positive chamber comprises:
a first positive chamber;
a second positive chamber; and
a positive chamber passage selectively permitting fluid communication between the first positive chamber and the second positive chamber based at least in part on a position of the piston along the axis.

15. The suspension component of claim 14, wherein the piston is movable along the axis in the compression direction to an end position wherein the first seal is disposed beyond the positive chamber passage in the compression direction, sealing the first positive chamber from the second positive chamber.

16. The suspension component of claim 15, wherein, in the end position, the positive chamber passage is disposed beyond the second seal along the axis in the compression direction.

17. The suspension component of claim 14, further comprising an adjustment valve, wherein the adjustment valve is operable to adjust pressures in the negative chamber, the first positive chamber, and the second positive chamber.

18. The suspension component of claim 10, wherein the suspension component is a front fork for a bicycle.

19. The suspension component of claim 10, wherein the suspension component is a rear shock for a bicycle.

20. The suspension component of claim 10, wherein the suspension component is a seatpost for a bicycle.
